(19) United States
(12) Patent Application Publication
(10) Pub. No.: US 2025/0272939 A1
(43) Pub. Date: Aug. 28, 2025

(54) IMPROVED AUTHENTIFICATION METHOD

(71) Applicant: Franck Guigan, Paris (FR)

(72) Inventor: Franck Guigan, Paris (FR)

(21) Appl. No.: 17/753,528

(22) PCT Filed: Aug. 13, 2020
(86) PCT No.: PCT/FR2020/000221

§ 371 Date: Mar. 16, 2023

(30) Foreign Application Priority Data
Sep. 7, 2019 (FR) 1909856
Sep. 12, 2019 (FR) 1910111
Jun. 18, 2020 (FR) 2006356

(51) Int. Cl. G06V 10/143; G06T 7/73; G06V 20/00

(52) U.S. Cl. CPC G06V 10/143; G06T 7/73; G06V 20/95

(57) ABSTRACT

The photographic acquisition method known as “killing the ambient light,” which involves calculating the difference between two acquisitions of the same scene, is known, particularly when it is applied to authentication by an authentication device equipped with a means, termed a marker, allowing the position to be determined in three dimensions, in which the photographic acquisition means are located, one under a given lighting and the other with an additional lighting. The change in lighting conditions must be carried out at the fastest possible pace, so that the acquisition device does not move between the two successive shots even if it is held in the hand, and so that the scene does not have time to change. To this end, an image is acquired as soon as the modification of the lighting conditions enables this marker to be recognized.

### CROSS-REFERENCE TO RELATED APPLICATIONS

This application is a national phase entry under 35 U.S.C. § 371 of International Patent Application PCT/FR2020/000221, filed Aug. 13, 2020, designating the United States of America and published as International Patent Publication WO 2021/044082 A1 on Mar. 11, 2021, which claims the benefit under Article 8 of the Patent Cooperation Treaty to French Patent Application Serial No. 1909856, filed Sep. 7, 2019, French Patent Application Serial No. 1910111, filed Sep. 12, 2019 and French Patent Application Serial No. 2006356, filed Jun. 18, 2020.

### TECHNICAL FIELD

The present disclosure relates to a secure method for authenticating documents comprising a marking whose appearance changes based on the viewpoint from which the documents are observed or based on the lighting conditions.

### BACKGROUND

The method consisting in taking two photographs with and without flash, to differentiate them in order to “kill the ambient light,” has been known for some time. Bryan Peterson's book “Flash Photography,” first published in 1952 and republished in 2011, discusses how to “kill the ambient light” by subtracting a photograph without flash from a photograph with flash.

Patent US20080158258A1 dated Dec. 27, 2006 (David B. Lazarus [US] and John D. Ogden [US]—General Instrument Corporation) describes a method involving acquiring a plurality of digital images at least at two different illumination levels from a controlled light source, and analyzing the plurality of digital images to obtain an image representing the lighting contribution provided by the controlled light source.

Patent U.S. Pat. No. 7,590,344B2 dated Sep. 15, 2009 (Georg Petschnigg [US]—Microsoft) describes a process for improving images taken with flash, that includes acquiring a first image captured with flash and ambient light, then a second image, corresponding to the first image, captured with ambient light, and using the first image and the second image to create a third image with flash only.

Patents WO2012136902 and WO2019141915A1 by Franck Guigan [FR] are known, which respectively describe a method for authenticating a marking whose appearance changes based on the viewpoint from which they are observed or based on the lighting, and a method for authenticating a marking of this type by comparing its appearance from one viewpoint with one of the known descriptions chosen as being established from a viewpoint among those closest to this viewpoint.

### BRIEF SUMMARY

Many authentication methods exist that involve visually acquiring a security marking, successively according to several different lightings, and even under several different viewpoints. The main advantage of such markings is that they are more difficult to reproduce or falsify than markings whose appearance is unique whatever the viewpoint under which they are observed or whatever the lighting.

When two successive photographs are taken under several different lighting conditions, with a hand-held camera, for example, one being taken under ambient lighting and the other with an additional light source, it is difficult to obtain two images depicting exactly the same scene, either because the acquisition means has moved, or because the scene has changed between the two acquisitions.

When an additional acquisition is then carried out from a different viewpoint, a means of circumventing the authentication method has been devised that consists in carrying out two acquisitions of the marking each corresponding to a different viewpoint instead of carrying out two acquisitions of the same marking.

The object of the present disclosure is to solve these two problems.

The present disclosure relates to an authentication method comprising, with a photographic acquisition means equipped with a computer, two successive photographic acquisitions of an optical authentication device comprising a characteristic marking and a so-called marker means enabling the computer to determine, by optical means, the viewpoint from which the photographic acquisition means sees the authentication device, the two acquisitions being done under two different lighting conditions, wherein the second acquisition is done less than one second after the computer has succeeded in recognizing the marker after the modification of the lighting conditions.

### BRIEF DESCRIPTION OF THE DRAWINGS

The present disclosure will be well understood, and other aims, advantages and features thereof will appear more clearly, on reading the description that follows, which is illustrated by FIGS. 1 and 2.

FIG. 1 is a comparison between a photograph taken in ambient light, on the left, and a photograph taken in ambient light with an additional light source, which is the flash of the acquisition means, on the right.

FIG. 2 shows, on the left, the result of the operation of subtracting the acquisition in ambient light from the acquisition carried out under ambient light and an additional light source. This so-called differential image represents the effect of the flash, which may also be understood as the calculation of the image after having “killed the ambient light,” and, on the right, the differential image calculated with the same method as that used to calculate the image on the left, but in the case where the acquisition means has been moved between the two acquisitions done with and without an additional light source. The image on the left is the reference, which could also have been obtained by taking a photograph with only the additional lighting, and the one on the right has many defects that mean it is not representative of this reference and therefore does not authenticate the authentication device. As for the image of FIG. 1, the marker is the circumference of the printed marking, which is deformed based on the perspective, and the analysis of which allows the computer to calculate the position of the acquisition means with respect to the authentication device.

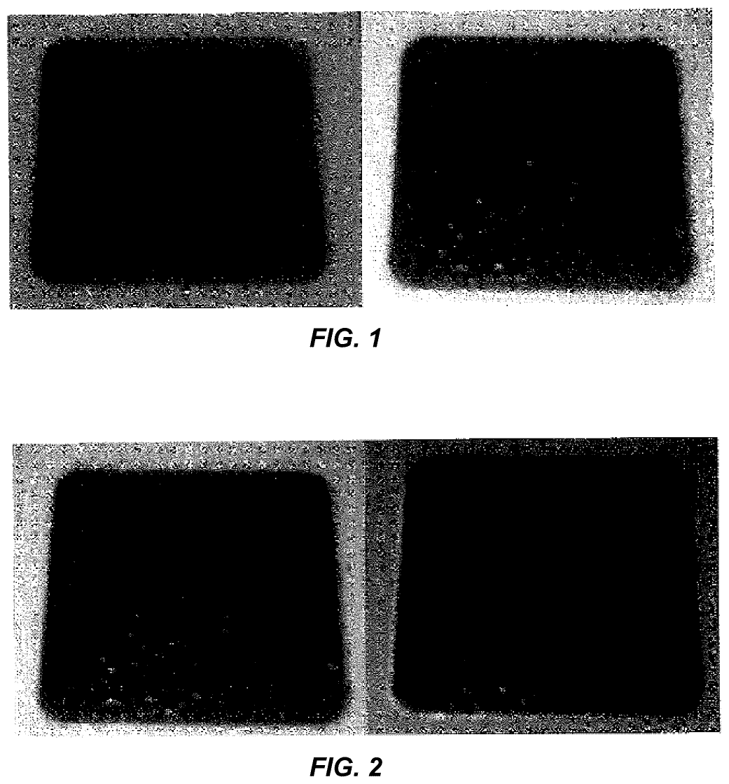

### DETAILED DESCRIPTION

In a preferred embodiment described in the aforementioned documents WO2012136902 and WO2019141915A1, two acquisitions are done under two different lighting conditions, and a so-called differential image is calculated by subtraction.

According to a preferred embodiment, one of the lighting conditions is ambient lighting and the other additionally comprises additional lighting. In this case, the differential image represents the scene illuminated by the additional lighting alone, and it is this image that is compared with a reference image done under the additional lighting alone.

The method of the present disclosure involves acquiring the two images at a fairly rapid pace so that the framing of the acquisition of the marking and the viewpoint under which it is seen by the acquisition means do not change too much between the two shots according to the two successive lighting conditions, while ensuring that the computer is able to recognize the marker and deduce therefrom the position of the photographic acquisition means with respect to the authentication device. The second acquisition must be done quickly, less than a second after the computer has succeeded in recognizing the marker after the modification of the lighting conditions, but advantageously, it is launched as soon as the computer has succeeded in recognizing this marker after the modification of the lighting conditions.

According to a first embodiment, a shutter speed/lens aperture pair is manually chosen such that an image is obtained under the two lighting conditions that allows analysis of the acquisition of the marker in order to deduce the position of the acquisition means with respect to the marking. In this case, the two acquisitions may be done in as short as a time interval as desired.

The preferred method of achieving this is to perform a first acquisition under a first lighting condition, and one or more additional acquisitions after varying the shutter speed and/or lens aperture until the computer can no longer determine the position of the acquisition means with respect to the marking under the second lighting condition. A shutter speed/lens aperture pair located below this limit is then chosen, allowing this position to be determined under this first lighting condition. We then move on to the second lighting condition to check that the computer is still able, with the same shutter speed and the same lens aperture, to determine the position of the acquisition means with respect to the marking.

It is not necessary for both acquisitions to be done, one when the additional lighting is completely on and the other when it is completely off. It suffices for there to be a difference in the intensity of this additional lighting between the two acquisitions so that the differential image depicting the scene illuminated by the additional lighting alone can be calculated.

This first embodiment is not always possible because many cameras automatically adjust the shutter speed and/or the lens aperture based on the lighting conditions, and do not allow manual adjustment of the shutter speed and/or lens aperture.

A second embodiment consists in this case in additional lighting being switched on intermittently at a rate greater than one cycle per second while photographic acquisitions are being carried out. As a result, the acquisition means does not have time to modify its settings too greatly between the acquisitions done with and without additional lighting. The successive photographic acquisitions may be done at a very rapid pace. Such intermittent lighting is also compatible with the first embodiment described above.

It is advantageous in this case to start switching on F additional lighting intermittently before taking the first of the two shots, to prevent the automatic adjustment from being able to correspond to the light conditions corresponding to a first shot with or without additional lighting, but so that it is already done according to an average value between the light conditions with and without the additional lighting.

The present disclosure also relates to an authentication method that includes establishing, according to one or other of the embodiments described above, a description referred to as a “subsequent 2D description” of an authentication device and comparing it with a description referred to as a “2D reference description” of the authentication device, the subsequent 2D description being established from a viewpoint close to that used to establish the 2D reference description. It thus allows improvement not only of the methods described in the aforementioned patent WO2012136902, but also of those described in WO2019141915A1, according to which several reference descriptions are established from different locations, to compare a subsequent description with the 2D reference description established from the viewpoint closest to that used to establish the subsequent 2D description.

The inventor of embodiments of the present disclosure has imagined a fraud method that involves producing two images, one of which represents the view of the authentication device from a first viewpoint or under a first lighting condition, and the other, the view of the same authentication device according to a second viewpoint or under a second lighting condition, and presenting the acquisition means responsible for the authentication operation with the two images one after the other. These two images are very easy to reproduce or falsify, and it becomes easy to believe that the original has been provided when it is in fact two reproductions that may, for example, be photographic.

None of the methods offered on the market seem to be wary of this method of fraud and to have provided a solution thereto. This represents a considerable risk, especially when these authentication devices are used to identify people online, or to authenticate means of payment such as credit cards online.

In order to prevent scammers from using this method, an improvement of the present disclosure consists in the method according to the present disclosure comprising a step of verifying that the two successive acquisitions indeed relate to the same authentication device.

Several embodiment versions of this improvement are proposed.

According to a first embodiment version of this improvement, the authentication method comprises verifying that all or part of the authentication device is clearly seen by the acquisition means between two acquisitions.

The verification that all or part of the authentication device is clearly seen by the acquisition means is advantageously supplemented by verification that only a single copy thereof is seen. This verification consists in verifying that two parts of the authentication device are not simultaneously seen that are juxtaposed in such a way as to show that it is not the same authentication device.

This verification may be carried out randomly. Since the forger cannot predict when this verification will take place, it becomes very risky to use the fraud method that the present disclosure seeks to prevent.

It is in fact not necessary to see the entire authentication device; it suffices to verify that part of this authentication device is clearly visible and that no part of another authentication device is simultaneously visible, so that it is certain that the scammer could not replace the authentication device with two images representing its appearance from two different viewpoints or under two different lighting conditions.

Advantageously, the method comprises such a verification at least every half-second.

The method may also comprise verifying that all or part of the authentication device is clearly seen by the acquisition means for all the images acquired successively by it, and that the position of the authentication device in the whole series of images acquired is consistent with the change in viewpoint and/or lighting

According to a second embodiment version of this improvement, it is verified that the authentication device has not been replaced by an electronic display screen successively displaying two appearances of the authentication device. Three methods are proposed to achieve this.

The first method consists in modifying the lighting conditions between two successive acquisitions to verify that the acquired image is indeed modified in the way in which the authentication device changes appearance based on the variation in the considered lighting conditions.

The second method consists in performing successive acquisitions with a short opening time of the lens, so as to detect characteristic changes in appearance of an electronic display screen that does not redisplay the images continuously, but rather according to its own unique refresh rate. Advantageously, this opening time is less than the refresh rate of the most common display screens, that is to say, one fiftieth of a second, but the lower this opening time, the better it is.

The third method consists in modifying the distance between the acquisition means and the image to be acquired between two acquisitions so as to cause moiré patterns, since the latter are characteristic of the screening resolution of the authentication device, which is most often very different from that of the electronic display screen.

In general, several successive photographic acquisitions may be obtained by analyzing a video acquisition.

### Applications

A particularly interesting use from an economic point of view is that in which the appearance of all or part of an object or a document is compared to see whether this object or document is indeed the one that was originally photographed and recorded.

Many applications therefore exist on the one hand in the fight against counterfeiting, gray markets and smuggling, and on the other hand in the fight against false documents and copies of works of art. The main markets targeted are therefore the repackaging of products and their instructions, passports and identity cards, driving licenses and, in general, all documents liable to be falsified, as well as the markings used to secure payments by card and the face-to-face or online identification of people.

1. An authentication method, comprising:
acquiring, with a photographic acquisition means equipped with a computer, two successive photographs of an optical authentication device comprising a characteristic marking and a so-called marker means enabling the computer to determine, by optical means, a viewpoint from which the photographic acquisition means sees the optical authentication device, the two successive photographs being acquired under two different lighting conditions, wherein a second photograph of the two successive photographs is acquired less than one second after the computer has succeeded in recognizing the marker after modification of the lighting conditions.

2. The method of claim 1, wherein acquisition of the second photograph is commenced as soon as the computer has succeeded in recognizing the marker after the modification of the lighting conditions.

3. The method of claim 2, wherein a shutter speed/lens aperture pair is manually chosen such that an image is obtained under the two lighting conditions that allows analysis of the acquisition of the marker to deduce the position of the acquisition means with respect to the marking.

4. The method of claim 3, wherein a first acquisition is performed under a first lighting condition, and one or more additional acquisitions is performed after varying the shutter speed and/or lens aperture until the computer can no longer determine the position of the acquisition means with respect to the marking under the second lighting condition, so as to choose a lens shutter/opening speed pair located below this limit.

5. The method of claim 4, further comprising verifying that the computer can always, with the same shutter speed and the same lens aperture, determine the position of the acquisition means with respect to the marking under the second lighting condition.

6. The method of claims 5, wherein the two acquisitions are done with a difference in the intensity of an additional lighting between the two acquisitions.

7. The method of claim 6, further comprising intermittently switching on additional lighting is switched at a rate greater than one cycle per second while acquiring photographs.

8. The method of claim 7, wherein the additional lighting is switched on intermittently before acquiring a first photograph of the two successive photographs.

9. The method of claim 1, further comprising acquiring an additional photograph of the authentication device, done from a different viewpoint, and verifying that two successive acquisitions relate to the same authentication device.

10. The method of claim 9, wherein the verifying comprises verifying that all or part of the authentication device is seen by the acquisition means between two acquisitions.

11. The method of claim 10, wherein the verifying comprises verifying that only a single copy of the authentication device is seen.

12. The method of claim 9, wherein the verifying comprises verifying that the authentication device has not been replaced by an electronic display screen, successively displaying two appearances of the authentication device.

13. The method of claim 12, further comprising modifying the lighting conditions between two successive acquisitions of the two successive photographs to verify that the acquired image is indeed modified in the way in which the authentication device changes appearance based on the variation in the considered lighting.

14. The method of claim 11, further comprising successive acquisitions with an opening time of the lens of less than one fiftieth of a second.

15. The method of claim 11, further comprising modifying a distance between the acquisition means and the image to be acquired between two acquisitions.

16. The method of claim 1, wherein a shutter speed/lens aperture pair is manually chosen such that an image is obtained under the two lighting conditions that allows analysis of the acquisition of the marker to deduce the position of the acquisition means with respect to the marking.

17. The method of claim 16, wherein a first acquisition is performed under a first lighting condition, and one or more additional acquisitions is performed after varying the shutter speed and/or lens aperture until the computer can no longer determine the position of the acquisition means with respect to the marking under the second lighting condition, so as to choose a lens shutter/opening speed pair located below this limit.

18. The method of claim 17, further comprising verifying that the computer can always, with the same shutter speed and the same lens aperture, determine the position of the acquisition means with respect to the marking under the second lighting condition.

19. The method of claims 1, wherein the two acquisitions are done with a difference in the intensity of an additional lighting between the two acquisitions.

20. The method of claim 19, further comprising intermittently switching on additional lighting is switched at a rate greater than one cycle per second while acquiring photographs.
